(19) United States
(12) Patent Application Publication
(10) Pub. No.: US 2023/0408149 A1
(43) Pub. Date: Dec. 21, 2023

(54) Compound-Eye-Hexlens Covers for Solar-Ponds and Lagoons

(71) Applicant: John D. Walker, Kuna, ID (US)

(72) Inventor: John D. Walker, Kuna, ID (US)

(21) Appl. No.: 18/177,895

(22) Filed: Mar. 3, 2023

Related U.S. Application Data
(60) Provisional application No. 63/366,681, filed on Jun. 20, 2022.

(51) Int. Cl. F24S 10/17; C08L 67/03; C08L 23/06; H02S 40/22; H02S 40/44; H02S 30/10; F24S 10/13; A01K 61/10

(52) U.S. Cl. CPC F24S 10/17; C08L 67/03; C08L 23/06; H02S 40/22; H02S 40/44; H02S 30/10; F24S 10/13; A01K 61/10; C08L 2201/06; C08L 2201/10; C08L 2203/204; C08L 2201/08; C08L 2207/066; C08L 2207/062

(57) ABSTRACT

A floating pond cover comprised of a plurality of convex spherical lenses of suitable polymer and uniform thickness arranged symmetrically at maximum packing density within a singular hexagonal floatation-cell-body (Cell), said Cell comprising one of a plurality of >10\hat{ }3 identical Cells, whereupon dispersed on totality of a Salt-Gradient-Solar-Pond (SGSP) or other pond-function/lagoon surface, providing coverage of >99%, forming a floating thermal insulation and evaporation barrier, whilst maximizing absorptance or reflectance of incident solar irradiance into/from the pond media. The plurality of hemispherical-surfaces of the lenses, being positioned uniformly within a hexagonal body are arranged, convex-side up, and extends upward from a horizontal x-y plane to a prescribed height above upper surface of said Cell, such that solar rays impinging on said plurality of lenses and floatation body are refracted through the transparent, opaque or translucent Cell-body into said pond media providing functions of evaporation control and insulation for (TES), electric power generation, desalinating saltwater, potable water storage, sewage waste ponds, and protecting wildlife from toxic chemicals utilized in metallurgy, or in oil and gas extraction.

In the process of designing and excavating large open pond containments for storage of brine solutions, seawater, potable water for human consumption, agriculture, and toxic reagents for minerals and oil/gas extraction, floating pond covers become an important remedial feature in overcoming evaporation losses to atmosphere, which in high deserts, can amount to 3 m or more annually to atmosphere in such exposed environments.

A simple concept in mitigating these lost resources utilizes a floating pond cover comprised of Hexagonal Cells wherein-but not limited to—19 plastic balls, working as an assemblage of spherical lenses are packed uniformly within a hexagonal frame to maximum 2-dimensional density, and wherein the fractional space between all adjacent balls is sealed by welding the interior assembly to a lattice structure composed of a single or double-layer plastic sheet of same material and nominal thickness as said balls and frame. Accordingly, >99.5% of pond areas are protected from evaporation loss, and more importantly, the floating pond cover becomes an effective solar collector, transforming the working media therein into a heat sink for, but not limited to, TES, sustainable salt and freshwater fisheries, chemical reagents for mining, and fracking in the oil patch, stored energy for power generation by Organic-Rankine-Cycle (ORC), and, heat recovery via LCZ in Salt-Gradient-Solar-Ponds (SGSP) for generating electric power and desalinating seawater in advanced multi-effect-distillation (MEDX) plants.

Images (11)

Classifications

Refracting lenses for thermal energy storage in SGSP evaporation control, and insulation for solar TES, potable water storage, chemical processing & metallurgy, wastewater treatment lagoons, aquaculture & mariculture.

### DESCRIPTION

### Cross-Reference to Related Applications

This application claims benefit to Provisional Patent-Pending Application No. 63/366,681 filed Jun. 20, 2022, by John D. Walker, and entitled HEXLENS FLOATING SPHERICAL LENS COVERS FOR SOLAR PONDS AND LAGOONS, which is hereby incorporated by reference;

This application is further related to and incorporates by reference non-provisional application Ser. No 16/272,768, filed Feb. 11, 2019, now U.S. Pat. No. 10,987,609, and entitled POLAR-LINEAR-FRESNEL-CONCENTRATING SOLAR-THERMAL POWER AND DESALINATION PLANT, which is hereby incorporated by reference in its entirety, and U.S. patent application Ser. No. 16/951,345, of same title, filed Nov. 18, 2022, and U.S. Nonprovisional application Ser. No. 18/048,193, filed Oct. 20, 2022, the contents of each of which is incorporated by reference.

### TECHNICAL FIELD OF THE INVENTION

The present invention relates generally to field of thermal energy storage systems, and more particularly, to SGSP facilities wherein floating liners are emplaced to (1): reduce evaporation losses of water from the saltwater ponds, (2): maximize absorptance of incident beam solar irradiance, providing a thermal energy source to desalinate seawater and generate electricity using Polar-Linear-Fresnel-Concentrating (PLFC) or other CSP designs, and (3): recycle waste Brine solution from a nearby desalination plant utilizing heat transfer via heat exchangers immersed within the LCZ of said SGSP, providing latent heat energy for functions of seawater desalination and power generation (4) provide a floating insulation barrier thereby minimizing losses of thermal energy stored (TES) in the pond during nighttime hours or inclement weather.

### PRIOR ART

SGSP and similar pond designs engineered at improvising TES and evaporation control, have, since the mid-20^{th} century incorporated the use of large-area floating plastic liners composed of various woven fabrics and plastics, while shown to be effective are subject to photo-degradation and tearing under normal weather in most locals: UV radiation, moderate-heavy winds, snow and rain precipitation, and extreme ambient temperature swings, not to mention labor costs in regards to deployment and removal of said liners.

In response to this, several pond-cover systems have been developed by Industrial & Environmental Concepts, Inc. (IEC) and others, wherein lightweight individual balls or cells composed of recyclable HDPE or similar plastic are dispersed in quantities ranging from <10\hat{ }5 to >10\hat{ }7 cells, effectively covering ponds and lagoons in their entireties, thereby reducing pond-evaporation rates by >89% whilst primary function being absorptance of IR irradiance wherein heat transfer into the pond media serves multi-purpose functions of TES: examples of which include electrical power generation, seawater desalination, agriculture & aquaculture, regulating temperatures of reagents used and recycled in the mining industry, oil & gas extraction, light and heavy industries. A notable advantage of implementing the use of floating Cells for pond covers is the deployment of such Cells is less labor-intensive than that borne in laying out and welding single—or double LDPE membranes across large open containment areas.

One company, AWTT (Advanced Water Treatment Technologies), has an innovative solution to overcome some of the problems associated with large scale floating liners and more recently the floating balls cover systems, by using a simple geometric concept, wherein identical opaque HDPE hexagon floating Cells are distributed en masse; typical orders of magnitude ranging from ‘n’×10\hat{ }5 to >10\hat{ }7 Cells, on a pond or lagoon surface to point of overflow at the pond limits. As the floating hexagonal elements are dispersed across the surface, they tend to attract to one another by a very imperceptible gravitational force between Cells, wherein the equal length sides are the point of least resistance for forming a continuous floating field, or cover-liner with a virtually seamless appearance, resulting in an effective liner of up to 99% pond coverage.

### BACKGROUND

Those of us growing up in the “Star-Trek” generation of the 1960's-‘70’s may recollect one of the earlier classics produced by the late Gene Roddenberry, wherein Captain Kirk was pitted in a fight to the death against a hilariously cuddly reptilian creature known as a Gorn, one of which outstanding anatomical features were a pair of enormous compound eyes. The following invention in part resembles these eyes, perhaps being yet another manifestation of the Sci-Fi author's imagination finding its way into real-world life situations, courtesy of an imaginary intelligent being from the 9^{th} planet in the Tau Lacertae star system; celestial coordinates being R.A. 22 h 44 m/Dec. 45° N.

In the continuing quest worldwide for concentrated solar power (CSP) and seawater desalination systems, low-cost, energy efficient designs such as polar-linear-Fresnel-concentrators (PLFC) and advanced multi-effect-distillation (MEDX) plants respectively, are emerging technologies for producing electric power and fresh water. Thermal energy storage systems (TES), utilizing molten eutectic salts, generally composed of chlorides, nitrates and other inorganic salts in binary, ternary, and quaternary compounds, leading to the development of a single-temperature-thermal-energy storage system (SITTES), through which seawater is pumped through a plurality of lines and heat exchangers in the TES at various flow rates; accordingly, this SITTES is a multi-purpose facility, providing seawater working media to steam-cycle, organic-Rankine-cycle power generation using rotary-screw expanders, and low to moderate temperature MEDX desalination facilities.

Since the mid-20th century, an innovative TES method utilizing large-capacity (e.g., >300 m-square) salt-gradient-solar-ponds SGSP is increasingly applied in low-energy-input and low temperature desalination plants, operational examples found in Israel and other MENA nations, and the Southwestern United States. Typically, ponds are excavated using conventional earthmoving equipment, e.g., dozers and scrapers, by common cut-and-fill practice to several meters in depth, and by lining with impervious soils or clays, followed by overlining the entire excavated, graded and compacted earthworks by a heavy high-density-polyethylene (HDPE) or equivalent polymer liner; 80 mils (2 mm) in thickness. The MEDX desalination process necessarily reject waste-brine media (Brine) at a ratio of 2/3 : 1/3 distillate produced, with salinities exceeding 50 g/l typically being an upper value. In common current practice, the brine reject outflow from the desalination plant is either dispersed back into the sea using branched conduits spread out over a large area of seafloor to recycle the salts back to the sea in a diffused pattern, thereby reducing to a limited extent, environmental consequences to sea life.

In the arid MENA nations and desert Southwestern U.S., high ambient temperatures, low humidity, and strong or moderate wind velocities result in excessive evaporation rates, causing unacceptable waste of the water resource and excessive concentration of the Brine within the plurality of waste-ponds, resulting in supersaturation of said salts in the LCZ, thence excessive deposition of solid layers of chloride-precipitates on the pond floors. As noted in the Prior Art of this text, floating pond sheet liners are problematic in ponds of large dimensions.

It would be desirable to have a simple pond surface-liner comprised of individual cells using a polymer of robust properties, within a one—or two-layer (open- or closed) plastic body, specifically applied to a range of pond-storage containment objectives inside the greater CSP/desalination “Energy Park”, as well as in other applications, ranging from waste-water treatment, mining (metallurgy) process facilities, oil & gas drilling ponds, potable water for human consumption and agriculture.

### BRIEF SUMMARY OF THE INVENTIONS

Accordingly, there is need for a floating pond & lagoon cover-system that combine to mutual benefit the respective attributes of both IEC's Flotation Balls and AWTT's HEXPROTECT™ hexagonal floating cells into a simple design wherein a plurality of optical lenses formed by cutting in half- or lesser-fraction thereof, said Floatation Balls, and all of which are fabricated in mass by common plastic-molding methods from a specific polymer, wherein properties of albedo, absorptance to and refraction of beam solar irradiance at various wavelengths from the near-infrared through the visible light and I.R. regime are chosen in accordance with the principle function of the pond or lagoon: (1) TES storage in a plurality of SGSPs, wherein recycling of Brine reject media from a nearby MEDX facility enables furtherment of seawater distillation and electric power production augmented via direct solar irradiance and waste heat transfer amongst the plurality of Brine-SGSPs (2) maximize insulation properties of the liner by selecting a polymer of high reflectance, e.g., albedo >90%, thereby minimizing heat transfer from the Sun's energy into the pond; specifically applications where water temperatures must remain approximate to mean ambient air temperatures, such as potable water storage, and aquaculture industries (3) maximize absorptance of near-IR and visible light rays into the pond working media by utilizing transparent polymers suited to collection and refraction of the beam irradiance, such that sunlight penetrates into the three-thermocline zones of the SGSP; transferring and maintaining heat therein, accordingly, (4) maximize absorptance of IR irradiance into the SGSP, by utilizing a polymer of very low albedo e.g., ab<3%, or equivalent to “black velvet” surface of high absorptance; transferring heat therein and maintaining TES in the plurality of SGSPs, whilst precluding growths of algae and other photosynthetic flora within the pond working media, (5) minimize evaporation for all functions heretofore described, wherein the gap-ratio for the plurality of HEXLENS elements dispersed at maximum surface packing density in said pond or lagoon is <0.5%, approximating a 100%-objective accordingly, (6) protect birds and other wildlife from falling into and drowning into SGSPs, freshwater storage facilities, sewage ponds, or being poisoned by chemical reagents utilized in petroleum, mining, and industries.

### BRIEF DESCRIPTION OF THE DRAWINGS

For better understanding of the described devices and functions of the floating-spherical lens designs, reference should be made to the Detailed Description below, in conjunction with the following images, in which same reference numbers, and their respective locations in text refer to corresponding items throughout said figures.

### List of FIGS. (10)

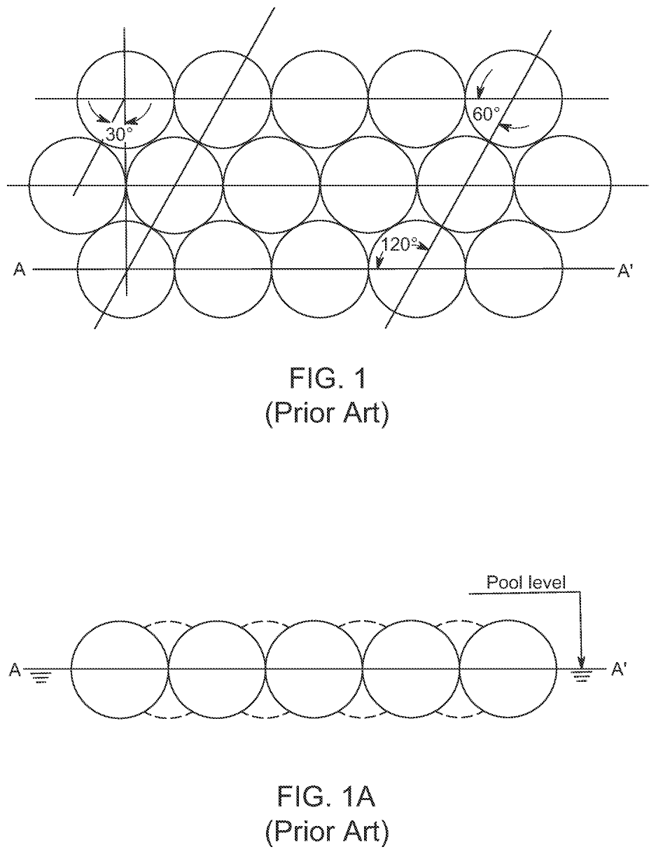

FIG. 1: Prior Art is a floating-ball concept developed by IEC for TES and evaporation control, wherein individual opaque HDPE balls are distributed across the pond or lagoon surface at maximum packing density, thereby illustrating an optimum geometry of 30° offset between rows in said packing density, wherein total pond coverage is 89.6%.

FIG. 1A: IEC Flotation-Balls showing x-section perspective on pool surface.

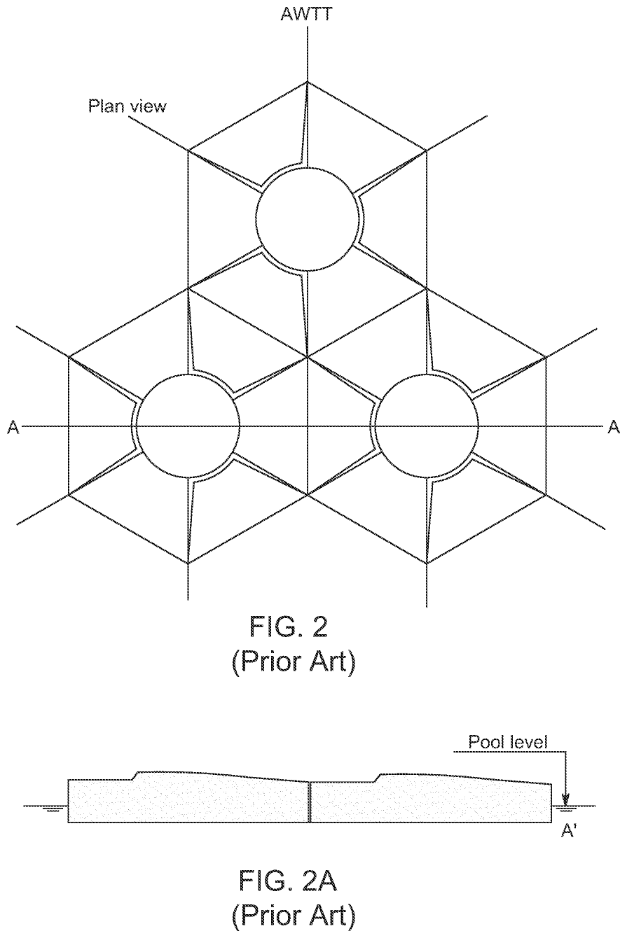

FIG. 2: Prior Art is a floating hexagonal cell concept: Hexprotect™, developed by AWTT, for functions of evaporation control and TES. Composed of opaque HDPE, with or without a foam-filling material, it affords up to 99% coverage over ponds and lagoons.

FIG. 2A: AWTT Hexprotect x-section with embodiment of Foam-Filling within ea. cell.

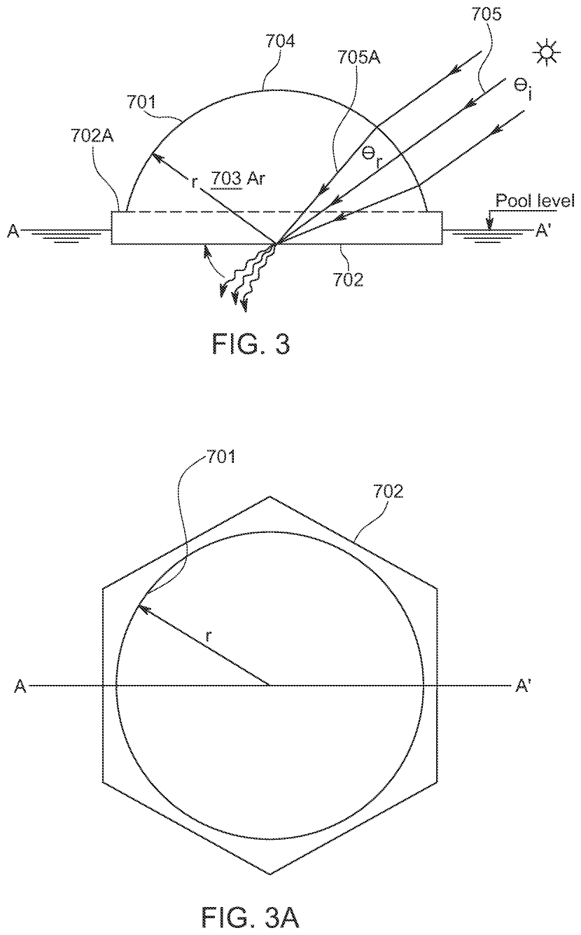

FIG. 3 and FIG. 3A: Prior Art are floating optical-hexagonal cell concepts designed by this author: HEXLENS-T and HEXLENS-B, utilizing transparent (e.g., PET) and opaque (e.g., HDPE or LDPE) polymers respectively, wherein a convex spherical lens fused to a hexagonal base cell-element functions as a lens to refract incident beam solar irradiance into a pond or lagoon for, but not limited to TES and evaporation control.

FIGS. 3B, 3C, 3D, and 3E: Prior Art, are various embodiments of singular convex spherical-cap lenses designed by this author, wherein welded to a hexagonal-cell base element, and showing their respective functions of absorptance or reflectance of incident beam irradiance, in accordance with albedo or luster of the polymers' compositions, respectively.

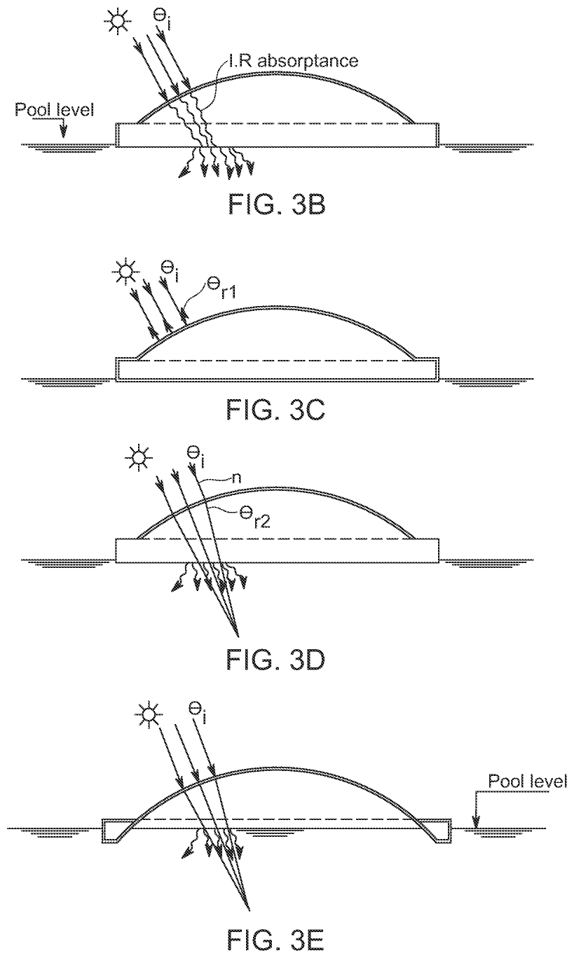

FIG. 4 is an idealized representation of sunlight refraction thru a thin transparent lens composed of PET into a working pond or storage pond media

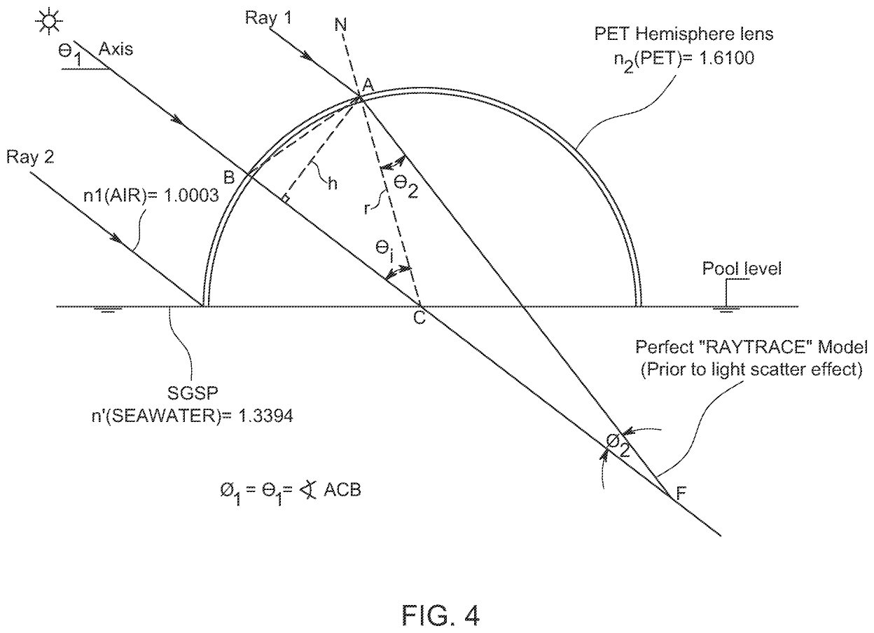

FIG. 5 & FIG. 5A is a floating OPEN-COMPOUND-EYE-HEXLENS “Cell” composed of a plurality of, but not limited to, e.g., 19 spherical balls confined within a singular rigid hexagonal frame (Skirt) at maximum hexagonal packing density, welded to one another into a honeycomb-structure by a singular rigid plastic sheet composed of same polymer as said lenses, such that all 19 ball elements touch one another at points of contact in common (six-maximum-interior), or at the limits formed by said hexagon (three or four) points-exterior, and, wherein the totality of said Skirt is extended to a depth equivalent to same depth as the totality of said 19 spherical balls.

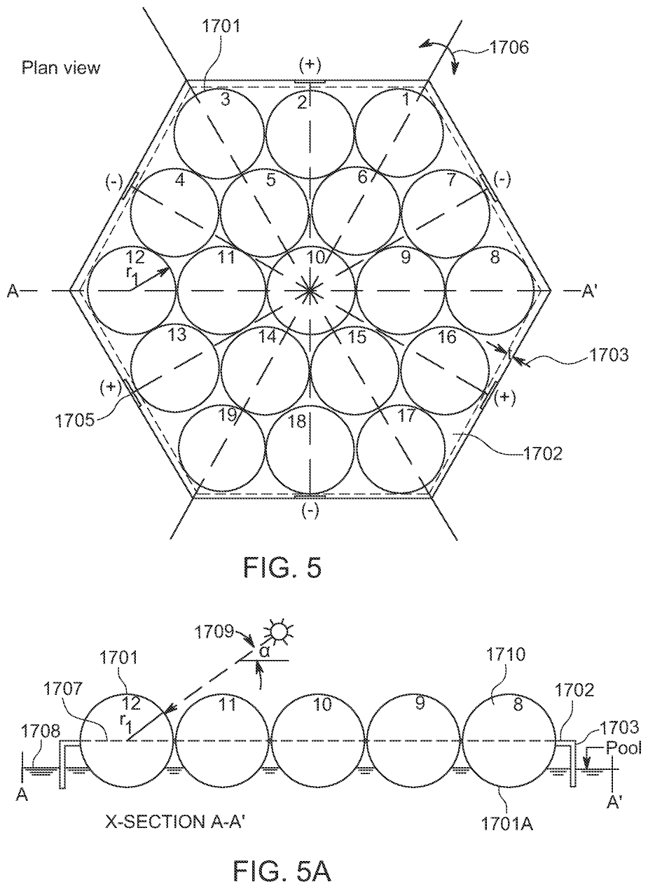

FIG. 6 & FIG. 6A is an embodiment of FIG. 5 & FIG. 5A wherein the height of said hexagonal frame (Skirt) is raised to extend vertically the same height above the horizontal reference centerline as below, transforming totality of said Open-Compound-Lens into (“Invertible Cells”); thereby facilitating ease of deployment of an entire floating-pond-cover by simply deploying required number of Cells from end-dump-trucks, regardless of orientation, saving labor costs accordingly.

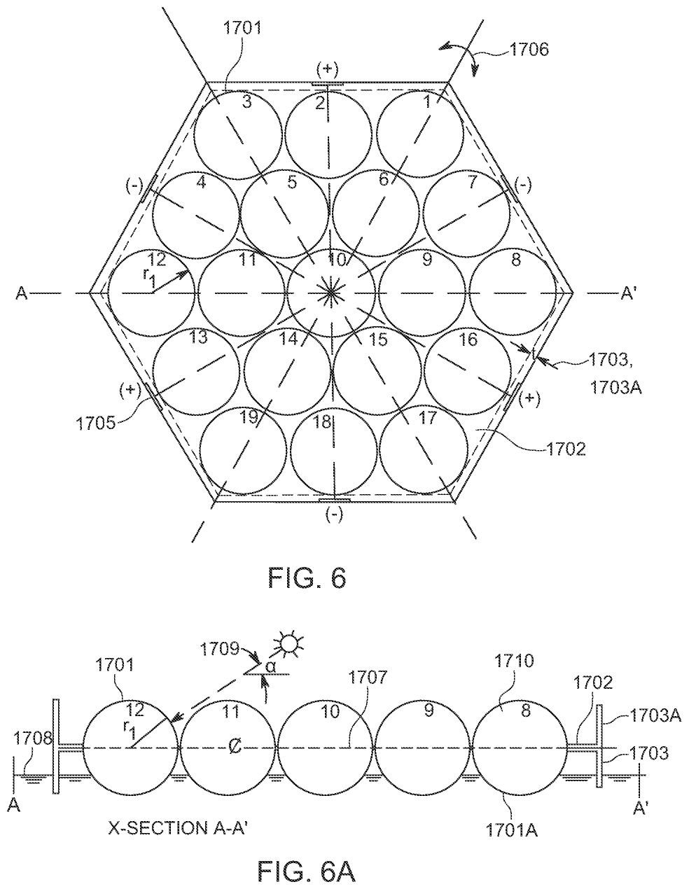

FIG. 7 & FIG. 7A is a floating CLOSED-COMPOUND-EYE-HEXLENS Cell comprised of a plurality of, but not limited to, e.g., 19 spherical balls confined within a rigid hexagonal frame at maximum hexagonal packing density, and welded into optimal packing arrangement by two rigid plastic sheets conformed to one another, composed of same polymer as said lenses, such that all 19 ball elements are truncated by two horizontal planes such that the entire cell apparatus is a hollow one-piece floating device wherein the lower half of said Compound-eye-HEXLENS cell is a mirror-image of the top-half; thereby negating the issue of correct dispersal orientation in a floating pond liner system, saving labor costs accordingly.

Furthermore, by offsetting the top and base elements by a height of “H” cm truncates the hemispherical sections into a singular water-tight floatation cell, optimized to collection of beam solar irradiance such that there is minimal wasted solar collection area around the base of each lens due to interference from the totality of adjacent lens elements at low solar incident angles, and,

Thereby creating a floating lattice of plurality of Compound HEXLENS Cells providing all functions of (1) evaporation control, (2) TES, (3) insulation (4) solar energy absorption and heat transfer, or (5) solar energy rejection (maximizing albedo).

FIG. 7B is an embodiment of a CLOSED-COMPOUND-EYE-HEXLENS Cell shown in FIG. 7A wherein entirety of Cell volume is packed with a “closed—or open—cell-type” Foam-Filling of same polymer as used in each Cell manufactured, and by extension over the totality of the floating pond coverage, adding an effective “R” insulation value of =>6.0 or 3.5 per-inch-thickness, respectively over said pond or lagoon.

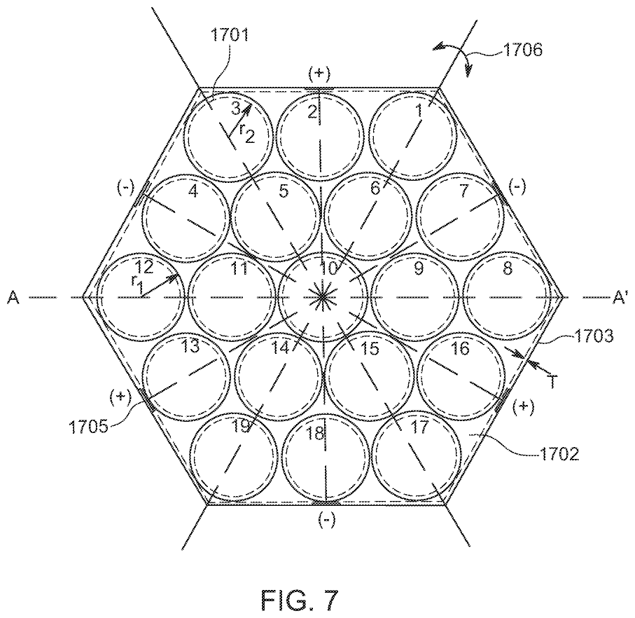

FIG. 8 & FIG. 8A is an embodiment of cell described in FIG. 7 & FIG. 7A wherein a plurality of vertical straps of plastic composition are used to tie the upper and lower-halves of said Cell assembly at strategic points central to said Cell, such that differential expansion (ballooning-effect) is lessened due to high ambient temperature fluctuations.

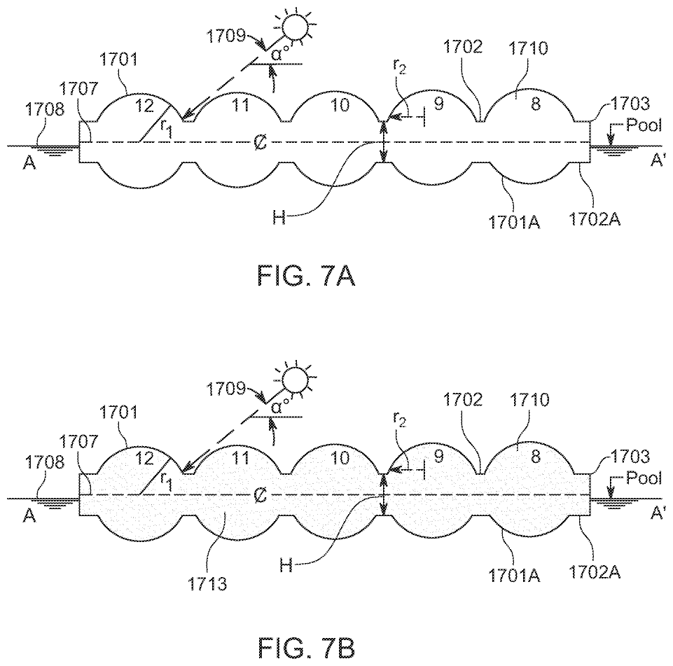

FIG. 9 & FIG. 9A is a floating CLOSED-COMPOUND-EYE-HEXLENS Cell comprised of a plurality of, but not limited to, e.g., 19 convex spherical Caps of radius “r2”>the radius of equivalent sphere “r1”, welded to an upper horizontally positioned surface lattice positioned within a rigid hexagonal frame (Skirt) at maximum hexagonal packing density, and whereupon, the ensuing assembly is precisely welded or attached at correct orientation by a plurality of plastic fasteners onto reverse side of a Lattice of same construction, such that the pair of said assemblies are offset from one-another by a nominal height of “h2” cm and, conforming to one another, such that the 19 spherical caps on the upper Lattice conform to the same number on the lower half, and being separated by the two horizontal planes such that the entire cell apparatus is a hollow one-piece floating device wherein the lower half of said Compound-Eye-HEXLENS cell is a mirror-image of the top-half; thereby negating the issue of correct dispersal orientation in a floating pond liner system.

### DETAILED DESCRIPTION

The floating-spherical-lens apparatuses (Cell) described herein for improvising TES, evaporation control, and insulating properties in SGSP, metallurgical processing, oil & gas drilling-fluids, potable freshwater containment, wastewater treatment systems, and aquaculture/mariculture water storage ponds and lagoons, described herein in eight embodiments are composed of low-cost, 100% recyclable plastics readily available on the market, and are selected on the desired attributes fitting a specific application. All Cell-designs share a commonalty in design by integrating a singular thin spherical convex lens on a center-axis of a hexagonal floatation body and are dispersed in plurality of pond environments in numbers sufficient to create a blanket-like layer atop the pond/lagoon surface in entirety. Cell features diverge from one another with respect to two defining physical properties of the polymer: (1) reflectance (albedo), (2) transparency or opacity to near-UV, visible and IR irradiance reaching Earth's surface, thereby being a versatile application wherein the intent of the pond cover designs range from maximum absorptance, thence transmittance, of solar energy into a TES system, to maximum reflectance, thence maximizing insulation of the pond media therein.

1. Modeling of Hexlens Cell Elements

1.1 Astronomy: Effect of Site Latitude on Beam Solar Irradiance

A large portion of desert regions on Earth facing critical water shortage are in the southern temperate (Mediterranean) and subtropics—equatorial zones of the inhabited continents, 40° N−23.5° N, and 23.5° N−0°, respectively, and their southern hemisphere counterparts, affecting the design of floating pond Cells. A Typical desert-site latitude of 30° N is used to illustrate the problem.

### Example 1

Given: A coastal site latitude of 30° N in Mexico Φ=30.00°
Declination angle of the Sun-Earth axis: δ=23.45°
Summer-solstice altitude angle @ noon-zenith local time: a=90°+δ−Φ
For TS=1200 h: a=83.45°
Generally, a=sin\hat{ }−1((sin Φ*sin δ)+(cos δ*cos [symbol] *cos Φ));
[symbol] being the hour angle, which is: [symbol] =15° (TS−12)
∴ at 0800 h: a=36.5999°
Winter-solstice altitude angle @ noon-zenith local time: a=90°−δ−Φ
   a=36.55°
Spring/autumn equinox altitude angle @ noon-zenith local time: a=90°+0−Φ
   a=60°

The winter-solstice 12 o'clock-noon altitude angle of 36.55° above the southern horizon is also very near to that value of where solar collection efficiency is about 60% of that at noon, due to apparent-thickness of Earth's atmosphere at low altitude angles (cosine-effect) becomes a factor in effectiveness of solar collection, during winter, and early a.m., late p.m. hours, in general, including other mitigating factors: light scattered to space, absorbed by water vapor, smoke and dust, etc.

1.2 Spherical Lens Optics Reference: Sfu.Ca/˜Gchapman/@89414u.Pdf

Given:
From Jenkins & White: Fundamentals of Optics, p.50
Selected polymer: Polythene terephthalate (PET)
Lens Conventions *incident rays from left to right **opposite to mirrors
Origin of solar rays: infinity; incident rays are parallel
Radius of curvature of spherical lens: assume r=½ minor dia. of hexagon; r=15 cm
Refractive indices:

| | | |
|---|---|---|
| n-0 | medium of light origin: Sun in space | n-0 = 1.0000 |
| n* | water (pure) | n = 1.3330 |
| n1 | air~“space’ | n = 1.0003 |
| n2 | PET (range n = 1.58-1.64) | n2 = 1.6100 |
| n′ | seawater (3.65 wt. %) | n′ = 1.3394 |

By comparison, for a glass pane comprised mainly of SiO2 n=1.4776

Determine: A ray trace model for a HEXLENS cell with spherical lens of radius r=15 cm, at latitude 36.55° N, at winter solstice; local solar time of 1200 hours.

| | |
|---|---|
| Object distance s | s: (+) if left to vertex; (−) if right to vertex |
| Image distance s′ | s′: (+) if right to vertex; (−) if left to vertex |
| Focal length f | f = ray-trace BF center |
| | axis to focal point F |
| Measure from focal | f: (+) for converging; |
| point to vertex | (−) for diverging |
| Radius of curvature r | r: (+) for convex surfaces; (−) for concave |
| Object and image | Q: (+) if up, (−) if below x-axis |
| dimension Q, Q′ | |

FIG. 8A All rays leaving object point Q, where Q is at ∞, and passing thru spherical refracting surface are brought to focus at point F, where radius of curvature r controls the focus.

Begin with Snell's law:

| | | |
|---|---|---|
| where: | θ1 = α = 36.55° | n1 sin θ1 = n2 sin θ2 |
| then, | θ2 = 21.7157° | n1 = 1.0003, n2 = 1.6100 |

Ray-trace model for spherical lens @ 30° N site latitude; winter solstice

| | |
|---|---|
| θ1 = solar altitude angle α winter | θ1 = α = 36.55° |
| n1 = index of refraction (i.r.), air | n1 = 1.0003 |
| n2 = index of refraction, PET | n2 = 1.6100 |
| n′ = i.r., final medium entered seawater | n′ = 1.3394 |
| r = radius of curvature of lens surface | r = 15 cm |
| s = Earth - Sun distance | s = ∞ for parallel light rays |
| f = focal length: point B to point F | f = focal length on center axis, sol rays |
| | f = 36.68 cm |
| C = radius of curvature r, at point C | C is centered on ray center axis |
| ϕ1 = θ1: <ACB at vertex C center | θ1 = 36.55° |
| AB = chord on lens-arc points A to B | AB\hat{ }2 = (r1) \hat{ }2 + (r2) \hat{ }2 − 2(r1*r2) cos θ1 |
| | AB = 9.4073 cm |
| θ2 = deflection < CAF @ vertex A | from outer ray-trace 1 at point A on spherical lens |
| to point F at focus | from Snell's law, |
| | θ2 = 21.7157° |

Angle ABC on isosceles triangle inscribed in hemisphere: center axis-focus-ray 1,

| | |
|---|---|
| radius r, lens to center point | AC/sin b = AB/sin θ1 |
| | angle ABC =< BAC = 71.7258° |
| ∴ angle ϕ2 | ϕ2 = 180° − (<s ABC + BAC + θ2) |
| | ϕ2 = 14.8327° |
| ϕ2 = < Ray 1 to Axis at focus f | ϕ2 = 14.8327° |
| AF = refracted Ray 1 from point A on sphere to focus F: | |
| AF/sin b = AB/sin ϕ2 | AF = 34.8906 cm |
| ∴ Focal length (f) = BF on ctr. Axis: | |
| BF = f; | AB/sin ϕ2 = BF/sin BAF |
| | f = 36.6814 cm |

1 HEXLENS Geometry

1.1 Hexprotect™ System

Hexagonal floating-cell pond cover systems produced by AWTT under the label Hexprotect™ are fabricated from opaque, black HDPE plastic, a highly durable material with expected lifetime of ˜25 years, in a plurality of pond environments and solutions. The Hexprotect™ cell upper surface consists of a modified hexagonal plane truncated by a symmetrical three-raised ridges and three-level triangular depressions, all extending radially from a center point of the cell body; in one iteration, a slightly raised dome about one-third width of the hexagonal cell at its minimum width, is featured. Each cell upper (atmosphere-facing) and lower (pond-contacting) surfaces are separated by hexagonally-arrayed rectangular strips, height of several centimeters, cell width-to-height ratio typically being 4.5-3.5/1; long-axis and short axis, respectively, and wherein interiors are either hollow, or packed with a foam material.

Generally, the surface area of a flat hexagon is:

S.A.=(3*(SQRT 3)/2)*t\hat{ }2, where:

t is the length of one of the six equal sides of said hexagon.

1.2 HEXLENS-COMPOUND-EYE System

HEXLENS-Compound-Eye floating cells are utilized in pond coverage liners wherein the attributes of insulation and evaporation control and maximum collection of solar irradiances reaching Earth's surface is needed for TES in solar ponds, chemical processing facilities, aquaculture farms, and waste-water treatment facilities.

HEXLENS-Compound-Eye floating cell covers are composed of, but not limited to: PET, HDPE, LDPE, and polycarbonate; each polymer being site-specific to the properties of maximum or minimum absorptance to beam solar irradiance, insulation, and chemical resistance to the solution, seawater, contaminants, or working-toxic-metallurgical reagents, e.g., NaCN— (aq) contained beneath the plurality of said HEXLENS Cells in a pond or lagoon.

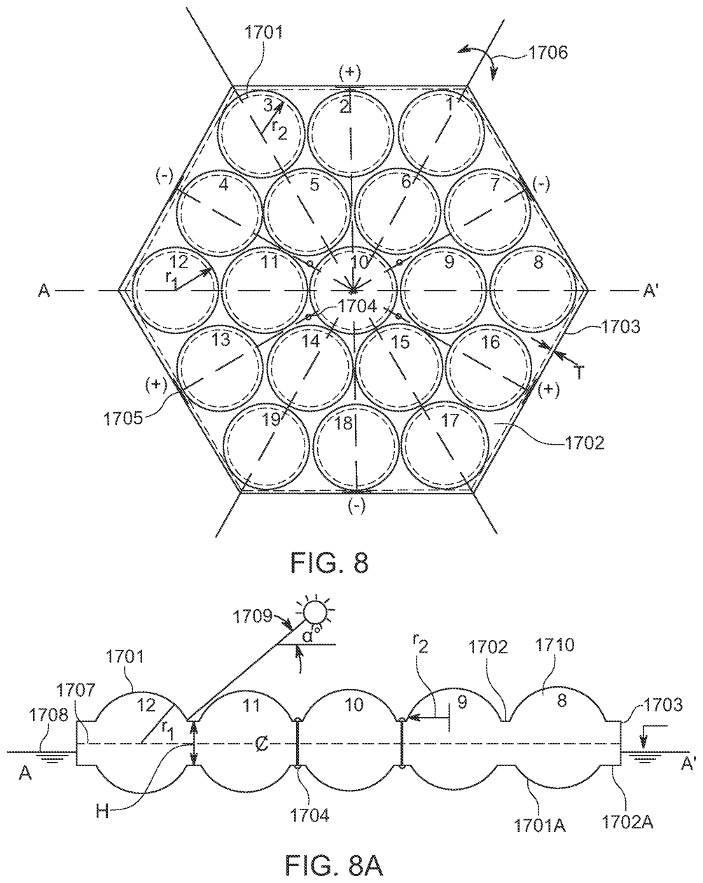

HEXLENS-Compound-Eye: Open-Cell-Configuration (FIG. 101)

Aside from material selection, a principal attribute of the HEXLENS-Compound-Eye Cell is a feature of a plurality of convex hemispherical lens formed by embedding and molding precisely, a plurality of balls (e.g., 19 spheres) horizontally within a horizontal plane the exact, or upper and basal to a singular or pair of plastic sheets of same thickness, thereby forming a water-tight assembly comprised of said 19 spheres, using common plastic fabrication processes, as in the manufacturing of plastic bottles. Being that one of the primary functions of the HEXLENS Cell-design is to maximize absorptance of, thence refraction of solar rays into the working pond media, the surface area of said totality of upper hemispheres (solar absorptance faces) of said 19 Cells is reduced at corresponding material cost savings from the original specification:

Application No.: 63/366,681, Docket No. WAL0103(PPA), wherein the area of the HEXLENS singular-hemisphere design is 1413.72 cm\hat{ }2.

### Example 2: A Single-Convex-Spherical HEXLENS Cell

Given: A circle wherein radius (rc) is inscribed exactly within hexagon of six equal sides (t) such that circumference touches center point (t/2) of each side of said hexagon.
Area of a circle (C-1) Ac=π*(rc)\hat{ }2, where rc=radius of circle inscribed within hexagon such that rc contacts center point of ea. Side at point t/2.
   Where radius rc=15 cm, corresponding area is 706.8583 cm\hat{ }2.
Area of a hexagon where circle (C-1) of radius rc=15 cm is inscribed precisely within, touching at all six points t/2:

Ahx=12*((0.5(rc/cos 30)*(rc/2))Ahx=799.4229 cm\hat{ }2
Example 3: A HEXLENS base hemisphere of radius r=15 cm, on the minor hexagonal base axis, the resultant Cell diameter being about one foot in an easily manufactured process.
   Area of hemisphere-lens is: A1=2 πr\hat{ }2 A1=1413.7167-cm\hat{ }2
   Area hexagonal base is: Ahx=12*(0.5(rc/cos 30)*(rc/2)
   Ahx=799.4229 cm\hat{ }2
Example 4: A HEXLENS Cell wherein a partial (Sectional) hemisphere-cap of height (h) on the Z-axis is <<radius r, (e.g., h=(r1−r2)=2 cm), and r3=(r1−h)=13 cm; where said sectional-cap base radius r1=15 cm, fitting precisely atop the hexagonal body. Then, radius R of the whole hemisphere would be projected thus:

R\hat{ }2=(r3)\hat{ }2+(r1)\hat{ }2=19.8494 cm

Angle subtended from Z-axis to R=tan\hat{ }−1 (r1/R2)=49.0856°

Surface area of Sectional hemisphere-lens (cap) above base plane is

SA cap=π(r1\hat{ }2+h\hat{ }2)=719.4247 cm\hat{ }2

Checking by: SA=π(C\hat{ } 2/4+h\hat{ }2), where C=dia. cap base-plane; SA cap=719.4247 cm\hat{ }2

Which fits precisely within the 15 cm-dia. HEXLENS-base cell floatation device.

2 Properties

Physical properties of HEXLENS Cells designs, e.g., albedo, color, luster, transparency, opacity, determine degree to which solar radiation is refracted or reflected thru/from a floating HEXLENS Cell, optimizing absorptance and refraction, thence heat transfer into pond media, or minimize same in applications of maintaining pond temperatures equivalent to seasonal ambient at site-specific, respectively.

Various physical data for several polymers used in HEXLENS cells are tabulated herein:

SELECTED PROPERTIES OF VARIOUS POLYMERS
APPLIED TO HEXLENS CELL DESIGN

| | PET | HDPE | LDPE | Polycarbonate |
|---|---|---|---|---|
| PHYSICAL PROPERTIES | | | | |
| Density (g/cm\hat{ }3) | 1.3-1.4 | 0.93-0.97 | 0.91-0.94 | 1.20-1.22 |
| Refractive Index | 1.58-1.64 | 1.49-1.52 | 1.50 | 1.58-1.59 |
| Resistance to UV | Good | Good | Fair | Fair |
| 24-h Water Absorption (%) | <0.7 | .005-.01 | .005-.01 | 0.12 |
| THERMAL PROPERTIES | | | | |
| Thermal Conductivity (W/m · K) | 0.15-0.40 | 0.45-0.50 | 0.32-0.35 | 0.19-0.22 |
| Lower Working Temp. (° C.) | −40 to −60 | −70 | −70 | −40 |
| Upper Working Temp. (° C.) | 80 to 140 | 100 to 120 | 80 to 100 | 130 |
| Specific Heat (J/K/kg) | 1200-1350 | 1200-1350 | 1200-1350 | 1200-1300 |
| CHEMICAL RESISTANCE | | | | |
| Acids, Concentrated | Good | Excellent | Excellent | Poor |
| Acids, Dilute | Good | Excellent | Excellent | Good |
| Alcohols | Good | Excellent | Excellent | Good |
| Alkalis | Poor | Fair | Good | Good-Poor |
| Aromatic Hydrocarbons | Fair | Poor | Poor | Poor |
| Greases and Oils | Good | Good | Good | Good-Fair |
| Halogens | Good | Poor | Poor | Poor |
| Ketones | Good | Poor | Good | Poor |
| OPTICAL PROPERTIES | | | | |
| Refractive Index | 1.58-1.64 | 1.49-1.52 | 1.50-1.52 | 1.58 |
| Albedo: (/ color or luster) | .03-.95 | .03-.95 | .03-.95 | .03-.95 |
| Transmission % UV; 200-400 nm | 80-85 | 75-85 | 75-85 | <10 |
| Visible Light transmittance % | 80-90 | 80 | 80 | >90 |
| Short-wave-IR transmittance % | 82-92 | 82-92 | 82-92 | 82-92 |
| Long-wave-IR transmittance % | 2-18 | 2-18 | 2-18 | 2-18 |
| Emissivity: transparent HEXLENS | .90-.97 | .90-.97 | .90-.97 | .90-.97 |
| Economics: resin-cost (2020) $/t | | 930 | | |

3. Applications

COMPOUND-EYE-HEXLENS cells in floating pond liner systems are composed of one or all, but not limited to the family of plastics described, including the plurality of polymers numbered in hundreds which are not listed herein. Given that the selection process for a specific plastic is optimized for one or several functions, material used as well as geometry determines the HEXLENS cell ultimately suited to one or plurality of specific tasks.

| Function | PET | HDPE | LDPE | Polycarbonate | LENS Type | Remarks/Examples |
|---|---|---|---|---|---|---|
| SGSP/TES | X | X | X | X | T, O | Max. heat transfer |
| Fresh Water | X | X | X | X | O | Maximum reflectance |
| Drilling Fluids | | X | X | | O, D | Saline, & Fracking |
| Metallurgy | X | X | X | | T, O | NaCN; Au processing |
| Aquaculture | X | X | X | X | T, D | Fresh & Saltwater fish |
| Wastewater | | X | X | X | O, D | Sewage ponds |

T: Transparent
D:Transluscent
O: Opaque

3.1 Salt Gradient Solar Ponds (SGSP)

Transparent lenses are used in SGSP/TES ponds where solar collection is required throughout the economic solar-day for maximum energy-transfer into the pond working media, in situations wherein daily flow-thru of pond media to external devices is substantial, e.g., >10,000 m\hat{ }3/d; or in such saline environments wherein algal growths are insignificant wherein LCZ temperatures commonly attain 100° C. Natural analogues to these conditions are extant in various clear hot springs of Yellowstone, WY.

Opaque lenses, composed of black or dark-color plastic, of spherical hemisphere design or spherical caps are optimized for transfer of IR irradiance into SGSP/TES, wherein flow-thru or toxicity of the salt solutions is insufficient to preclude growth of algae or other plant biota.

3.2 Fresh Water Pond Storage

Opaque COMPOUND-EYE HEXLENS cells generally composed of, but not limited to, white or light color plastic, and of high albedo, (e.g., >0.90) thence insulation properties, are utilized in freshwater storage wherein temperatures are maintained approximate to seasonal ambient norms, thereby mitigating external parasitic power losses in heating or cooling the potable water recovered from desalination in reservoir-lagoon, whilst preventing growths of algae, spermatophyte plants, or controlling bacteria proliferation, and reducing evaporative losses. Exceptions are applicable in high latitudes wherein polymer material composed of black or other low albedo surface-color are utilized to control ice-buildup during the winter months.

3.3 Oil and Gas Fields

Saline media and other compounds mixed with water and injected into deep production boreholes to facilitate improved recovery of crude oil and natural gas, necessarily stored in containment lagoons, are covered with opaque COMPOUND-EYE HEXLENS cells to reduce evaporation rates, thence improve volumes available for recycling same media into nearby inactive wells for purpose of generating electric power via ORC utilizing rotary screw expanders, and fracking for enhanced recovery of oil/natural gas in fields nearing end of economic life. Accordingly, this liner design is also effective in preventing wildlife from entering said ponds by forming a visually unattractive setting for fowl and land animals to congregate.

3.4 Metallurgy

Mining gold and other metals entails storage of large volumes of toxic reagents in water, e.g., sodium cyanide solutions, in large open, lined containment ponds, for purpose of reuse; heap leaching of Au/Ag ores being a notable example. Typically, aqueous solutions of Na+CN− of pH ˜10.5 optimum are stored and recycled thru large ponds wherein concentration of said reagent is maintained at levels of 0.5 #-1.0 #NaCN/short-ton solution, the reaction with gold as follows:

2Au+4(NaCN)+O2+2H2O→2NaAu(CN)2+H2O2+2NaOH

Which is performed in distribution on the leach pads of crushed rock, in large volumes via sprinkler-lines laid out atop said leach pads, dissolving said elements for concentration in a secondary “pregnant pond” prior to adsorption of the gold-silver onto activated carbon columns for eventual recovery of concentrates therein by acidic-stripping, electrowinning and smelting stages, respectively. As the recovery process subjects both birds and land-animals to poisoning potential, and in high-latitude and high-altitude climates becomes less efficient due to icing and corresponding temperatures of solution approaching 0° C., standard operating procedure in numerous mine-sites is to deploy netting over the plurality of ponds to exclude wildlife from danger, and to maintain temperatures above freezing through friction-energy created via pumping thru the distribution lines infrastructure, and via external energy (heat) supplied through the mill site's power-plant. Alternatively, a concept utilizing HEXLENS cells comprised of black-opaque HDPE or LDPE are distributed en-masse throughout the totality of said pond areas in (1) absorbing direct solar irradiance in the IR spectral range, thereby transferring thermal energy to the Na+CN-solutions therein, and maintaining a working temperature well above ambient-air, (2) providing an effective insulation barrier, thereby creating limited TES within said ponds and supplementing the functions of Item(1), (3) creating an effective evaporation barrier, thence salvaging nearly 100% of water-bearing solutions in the process facility otherwise lost to evaporation over the pond surface areas (majority of evaporative losses in the heap leaching process are by far, beneath the the sprinkler lines on rock or crushed-ore-leach pads, thru evapotranspiration in the Au recovery process) in low humidity, arid and high ambient temperature climates, (4) providing an effective physical and visual deterrent to wildlife as part of a “greater-whole-design” (Items 1-4) which conventional netting alone does not attain.

3.5 Aquaculture and Mariculture

Transparent and translucent COMPOUND-EYE HEXLENS cells are applicable in small and large-scale sustainable fisheries, often incorporating pluralities of interconnected lagoons and ponds of many acres in size, the former being of function designed to maximize transmissivity of solar irradiance, thence thermal energy, into ponds which siting in mid or high latitudes necessitate fish species therein (e.g., tilapia) can proliferate during winter months. Accordingly, in colder climates HEXLENS-T cells with a fully or partial spherical-hemisphere-lens are distributed across the totality of the pond surfaces, each cellular element being of profile sufficient to maximize low-incident-angles solar-rays capture and absorptance, thence transfer of visible and IR rays into the pond media, creating (1) life sustaining temperatures to tilapia, anadromous ocean mullet, and other fresh or salt-water species of economic importance, (2) provide direct sunlight to ensure photosynthetic plants (which are food sources for both tilapia and mullet) are maintained in quantities necessary for oxygen production, thereby providing a locally grown food source for the fish in addition to those dispensed (e.g., soy-based pellets) by the farmer.

In subtropical to tropical climates, where pond temperatures naturally tend towards the ambient conditions under which the fish species are raised, the farmer is likely to choose a translucent plastic HEXLENS-D (diffuse) cell, thereby (1) preventing evaporative losses from the totality of the pond areas, whilst (2) precluding excessive irradiance from penetrating into the pond and overstressing the fish populations therein by excessive heating of the fresh or sea waters contained, with ensuing correspondingly high mortality rates, and (3) allowing visible light of the photosynthetically active regime (PAR)— about 400-800 nm— to penetrate the HEXLENS cell elements accordingly, with a diffuse polymer of opacity and color which filters out the more harmful rays, particularly in the far red-end and IR spectral classes; e.g., λ>730 nm.

3.6 Sewage and Wastewater

Mesophilic bacterium, being the primary anaerobic (no-oxygen-dependent) microbes utilized in digesting sewage, are most active in water temperatures ranging from 20°-50° C. (68°-122° F.); ideally, 25°-40° C. (70°-104° F.); (Hussein Abed Obaid Alisawi: Performance of Wastewater Treatment during Variable Temperature; 3/07/2020). Correspondingly, optimum conditions for aerobic (oxygen-dependent) microbial treatment of sewage ranges from 25°-35° C. (77°-95° F.); (Sara Heger, Ph.D.; May 8, 2017). In large population centers experiencing high-ambient summer temperatures (Cairo, Kuwait, Baghdad, New Delhi), ponds into which the sewage effluent are pumped into are covered with light-color opaque, COMPOUND-EYE HEXLENS-W spherical-cap cells wherein radius of curvature may exceed by 5 or 10-times (or more) than the radius of the individual hexagonal-base dimension, thence maximizing reflectance of incident solar rays, and, the individual cells also having been purged of all air and filled with an organic or inorganic foam packing, contributing to an insulating pond liner which attenuates excessive IR irradiance from transferring thermal energy, and thereby excessive heat, into said sewage pond, which otherwise is detrimental to the performance of sewage systems where either aerobic or anaerobic bacteria are utilized in digesting of the suspended solids and sludge-precipitate in the wastewater.

Conversely, in high latitudes and/or elevations experiencing low or moderate year-around temperatures, opaque COMPOUND-EYE HEXLENS cells comprised of black HDPE or LDPE-with or without insulating Foam-filling composed of same polymer-injected in totality of said Cells or translucent cells composed of same plastic, with or without an inert gas, filling, are dispersed over the totality of pond surfaces where practical, thence reducing the albedo of the major surface areas of pond-effluents not disrupted by the sewage agitation-pumps accordingly, to <0.05, and thereby providing a limited TES function in the pond by transmission of IR irradiance into the sewage media within, sustaining operating temperatures within the nominal range of 20-40° Celsius.

4. Economics

Following illustration shows the relative costs in materials a floating HEXLENS pond liner system composed of 60 mil HDPE incurs. The capital costs are shown to be obviously higher, than an equivalent sheet-liner of same material and thickness, but are offset by such extraneous factors being, but not limited to:

(1) Labor costs

(2) Recyclability

(3) Durability under extreme weather conditions

4.1 Material Costs

Calculate the comparative costs of applying the COMPOUND-EYE-HEXLENS floating pond cover as described in (FIG. 7, FIG. 7A) vs. conventional sheet systems using HDPE, LDPE or PET.

Assumptions

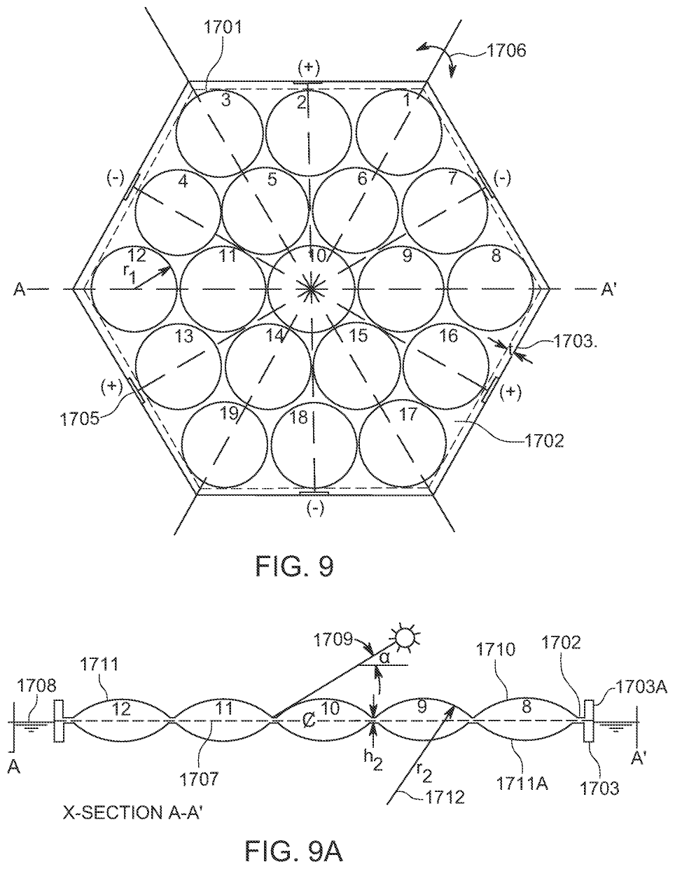

Given: A compound-eye-cell comprised of 19 cells packed into a hexagonal frame of minor axis length (R1) of: R1=15 cm; thence D1=30 cm across the short axis of hexagonal float.
Major axis length R2=2*(tan 30° (15 cm)); R2=17.32 cm=length/ea. of 6-sides of float.
Height Hex sides Ref: “SKIRT”=“Ab(hex)”, where h1=10% (D1); h1=3.0 cm; Area of basal form: Ab(hex)=6*(h1*R2) Ab(hex)=311.77 cm\hat{ }2.
Area/Hex. sheet: A(hex)=12*((0.5(R1/cos)30° *(R1/2))*A(hex)=779.42 cm\hat{ }2*before reduction/totality of compound-eyes-packing atop hex. plane
Compound eye: By scale reduction: d2=6.5 cm; thence r1 is radius of sphere (3.25 cm) projected onto single horizontal plastic surface as shown in FIG. 101. In a bi-planal arrangement shown in FIG. 102, a radius of sphere, e.g., Cell #3, is projected to the upper horizontal surface Lattice of the compound-eye assembly at height: h1/2, e.g., 1.5 cm, thence the minimum non-impeded solar ray at angle a=tan\hat{ }−1 (h1/2)/r1=24.78°.
   Area of singular eye-lens, given: r1=3.25 cm, radius of basal cap is r2. Thence, r2=cos a (r1); r2=2.95 cm, and: r3=r1−h1/2=1.75 cm
   SA Cap=n (r2\hat{ }2+r3\hat{ }2)=36.96 cm\hat{ }2; or SA cap=n (d2\hat{ }2)/4+r3\hat{ }2)=36.96 cm\hat{ }2. ΣSA caps: (n=1 . . . n=19)=702.26 cm\hat{ }2, total compound lens area, and net lattice (plate area): Pnet=A(hex)−19*(H*(d2\hat{ }2)/4=Pnet=148.94 cm\hat{ }2, that being area of hexagonal plate not under lenses.
Total plastics/Cell: Ap=Ab(hex)+2*(ΣSA caps: (n=1 . . . n=19)+2*(Pnet)=2014.17 cm\hat{ }2, recalling that base element of Compound-eye-assy. is mirror image of top

### Example 5A: COMPOUND-EYE-HEXLENS/Hemispherical Cell Design, Double Lattice Separation

Given references: 1. Sirius Plastics LLC 2. Poly-Flex ™: Geomembrane Lining Systems

| | | | Application (1) | Application (2) |
|---|---|---|---|---|
| Select polymer: High density polyethylene (HDPE) | | | HEXLENS cell | Conventional sheet |
| Base Cell dim./hex. Encl. | A(hex) cm\hat{ }2 | (a) | 779.42 | N |
| Skirt Area/Cell | cm\hat{ }2 | (b) | 311.77 | |
| Top Lattice Area (Pnet) | cm\hat{ }2 (=a-e) | (c) | 148.94 | |

| | | |
|---|---|---|
| SA/19. lens caps = 36.96*19 cm\hat{ }2 | (d) | 702.24 |
| Reduced Area under lenses = 33.183 *19 | (e) | 630.48 |

| | |
|---|---|
| Top area/Compound-Eye-Cell & 19 lenses = b + c + d | 1162.95 cm\hat{ }2 (incl. Skirt) |

Base area/Compound-Eye-Cell & 19 lenses=c+d 851.18 cm\hat{ }2; (mirror image-Skirt)

Tot. area/2-sided, invertible Compound-Eye-HEXLENS 2014.13 cm\hat{ }2

| | | | |
|---|---|---|---|
| Thickness: | t mils (mm = t*0.0254) | 60 (1.52 mm) | 60 |
| Sheet Density: | ρ (g/cm\hat{ }3) | 0.940 | 0.940 |
| Sheet weight: 60 mil HDPE | w (kg/m\hat{ }2) | 1.462 | 1.462 |
| Resin cost | C ($/metric t) | $930 | $930 |
| Tot. plastics used/Cell | A1t (cm\hat{ }2) | 2014.13 | N |
| Wt./Compound-eye-Cell | Wt (g/cell) | 294.5 | N |
| Weight: 60 mil HDPE liner | Wl (kg/m\hat{ }2) | N | 1.4622 |
| HDPE resin cost ($/kg) | Cr ($/kg) | 0.930 | 0.930 |
| Wt./Compound-eye-Cell | Wt (kg/cell) | 0.2945 | N |
| No. cmp'd-eye-Cells/m\hat{ }2 | n2 (cells/m\hat{ }2) | 12.83 | N |
| No. compound-eye cells/t | n3 (cells/t) | 3396 | N |
| Sample area: A2 (m\hat{ }2) | A2 = (100 m) \hat{ }2 | 10,000 | 10,000 |
| No. compound-eye cells/A2 | n2 * A2 | 128,300 | N |
| cost/compound-eye-cell | Chx ($/cell) | $0.274 | N |
| Installed Cost/m\hat{ }2 HDPE | Csm ($/m\hat{ }2) | $3.52 | $1.360 |
| HDPE cost/10,000 m\hat{ }2 | C/ha ($/ha) | $35,150 | $13,600 |

### Example 5B: COMPOUND-EYE-HEXLENS/Hemispherical Cell Design, Single Lattice Separation

See FIG. 5, FIG. 5A Reduce total area of each Cell by single-net-lattice area (Pnet), e.g., 148.94 cm\hat{ }2, thence “A-t” tot.=1865.23 cm\hat{ }2. Accordingly:

| | | | |
|---|---|---|---|
| HDPE cost/10,000 m\hat{ }2 | C/ha ($/ha) | $32,550 | $13,600 |

### Example 5C: COMPOUND-EYE-HEXLENS/Hemispherical Cell Design, Single Lattice Separation

See FIG. 6, FIG. 6A Increase “Skirt” height by 33% to 4.0 cm and centered above/below horizontal C.L. such that said skirt extends minimally below pool-level, and 2.0 cm above C.L. thereby forming an invertible compound-eye-HEXLENS Cell comparable to that utilizing a double-lattice described above (Example 5A); thence, “Skirt” Ab(hex)=415.69 cm\hat{ }2, and A-t tot.=1969.15 cm\hat{ }2. Accordingly:

| | | | |
|---|---|---|---|
| HDPE cost/10,000 m\hat{ }2 | C/ha ($/ha) | $34,364 | $13,600 |

4.2 Advantages of a COMPOUND-EYE-HEXLENS Floating Pond System

Though capital costs of HEXLENS Cells in all configurations is obviously higher than conventional floating HDPE or other plastics, labor and maintenance issues quickly offset these expenditures, as described herein:

4.21: Labor Cost and Mechanical

Conventional floating-sheet liners of single or double-thickness are rolled out across the pond floor by groups of >10 individuals in most cases, tasked to manually pull and secure the pond cover, with mechanical assistance as needed. Prior to filling the pond with working media, the sheets are welded together using a high temperature “gun” on common seams to each other, thereby attaining final desired area coverage in manageable sections. Ropes and winching devices are used to both (1) stretch and secure the floating liners in final position to prevent damage from weather-related events, and (2) reel-in the liners for section replacement as necessary for planned or unplanned repairs and maintenance. Following installation and throughout economic life of the pond cover, the floating sheets are subject to minor or major damages caused by high winds, or heavy rains and ice storms.

COMPOUND-EYE-HEXLENS using the single-layer-lattice sheet design (FIG. 5, FIG. 5A) being the least costly of the three embodiments herein, are dispersed by laying onto pond surface by dump-truck in controlled manner such that cells remain upright, as tended to by a handful of individuals overseeing the dispersal, possibly using a high-speed, fast loading “clay-pigeon” or “frisbee” casting device in achieving correct face-up dispersal. This pond cover is most practical in smaller areas, e.g., <10\hat{ }3 m\hat{ }2

In further embodiment of design (FIG. 5, FIG. 5A), height of the hexagonal skirt is increased at a minimal material cost, and centered on the Cell horizontal axis, such that the upper and base faces are identical and invertible, wherein the 19 spheres confined within the Hexagonal frame are simply balls truncated in half or lesser fraction (spherical-cap), each half, or cap being a mirror images of the other: see (FIG. 6, FIG. 6A),—and, presenting no deployment concerns accordingly, but lacking in totality of being a completely airtight cell. This pond cover is best applied in arid regions of low humidity and annual precipitation, whereupon, following a rare event of heavy rainfall, temporary “flooding” of the upper half of the floating liner assembly is alleviated shortly thereafter following the return of dry, windy conditions to seasonal norms. This pond cover is most practical in areas, e.g., >10\hat{ }3 m\hat{ }2, where said flooding minimally impacts the functions of evaporation control and TES over the lifetime of the project.

COMPOUND-EYE-HEXLENS cells of the twin-layer sheet design (FIG. 7, FIG. 7A),(FIG. 8, FIG. 8A) & (FIG. 9, FIG. 9A) are simply dumped into the pond disregarding orientation, as the top and bottom halves of said cells are identical. This applies both to the standard cell elements or those employing small magnets for enhanced adhesion of the entirety of the pond cover, obviating the advantages of these designs in all situations where pond and lagoon areas are of all sizes. Though the most expensive of the three designs herein, and conventional sheets, this system is by far the most superior product as the entire Cell from end-end is a one-piece, gas-filled bottle-like floating-insulator, and its applications in (1) TES in SGSPs; (2) fresh water storage at near-outside ambient air temperatures; (3) storage of chemical solutions used in mining, oil & gas, and other industries within specific temperature ranges; (4) Sewage treatment facilities; (5) protection of wildlife; and (6) evaporation control in all aforementioned topics.

4.23: Recyclability and Disposal Options

Upon attaining end of economic life (<=25 years), COMPOUND-EYE-HEXLENS cells are simply scooped up by loaders and dump trucks from a decommissioned pond and crushed into bales for transport to a recycling facility where they are reprocessed into new products. Alternatively, said bales of polymer are transported to an organic waste incinerator with appropriate protection for particulate emissions and burned along with other similar consumables, generating electrical power accordingly.

IMAGES (11)

| FIG. NUM. | ELEMENT | DESCRIPTION |
|---|---|---|
| FIG. 1, FIG. 1A | Prior Art | Floating balls cover conceptual as described by Industrial & |
| | | Environmental Concepts, Inc. (IEC) |
| FIG. 2, FIG. 2A | Prior Art | Floating hexagonal cell HEXPROTECT ™ concept advanced |
| | | by Advanced Water Treatment Technologies (AWTT) |
| FIG. 2A | Prior Art | X-section showing embodiment of closed or open-cell |
| | | Foam insulation material within Hexprotect ™ Cells. |
| FIG. 3, FIG. 3A | Winter model | Ray-trace diagram showing the Sun's light refracted thru a |
| | | spherical lens at a typical solar altitude angle of α = 36.6° |
| FIG. 3B, FIG. 3C, | | Four embodiments of singular Floating HEXLENS-Cell Pond |
| FIG. 3D, FIG. 3E | | covers, and attributes of absorptance or reflectance of |
| | | beam solar irradiance in energy-transfer to pond media |
| FIG. 4 | | A ray-trace model for a HEXLENS refracting spherical |
| | | lens cell at 30° N latitude. |

FIG. 5, FIG. 5A

| | | |
|---|---|---|
| 1701 | Compound lens | One of 19 transparent, opaque or translucent spherical |
| | | balls welded into a rigid floatation-ball assembly thereby |
| | | forming core elements of a Compound-Eye-HEXLENS-Cell |
| | | and uniformly packed at optimum geometry within an |
| | | equal-sided hexagonal frame (Skirt) #1703 |
| 1702 | Surface lattice | A horizontal planar sheet composed of same plastic as said |
| | | floatation balls into which the plurality of said balls are |
| | | welded uniformly into said planar sheet such that said |
| | | plurality of balls are divided into upper and basal |
| | | hemispheres, accordingly, forming a honeycomb-like |
| | | structure |
| 1703 | Outer wall skirt | an equal-sided hexagonal-frame welded to, and of same |
| | | thickness as said surface lattice, extending downwards |
| | | vertically beneath Pool surface (#1708) to depth sufficient |
| | | as to preclude outside ambient air from circulating |
| | | amongst said lattice/hemisphere interface |
| 1705 | magnetic disc | Thin magnetic disc of (+) or (−) polarity embedded flush to |
| | | center point surfaces of alternating wall (skirt) panels |
| 1706 | HEXLENS position | Relative positioning of adjacent Compound-Eye-HEXLENS |
| | | cells with respect to image detail of a central Cell |
| 1707 | Horizontal center line | A reference marker showing division of the Compound-Eye |
| | | HEXLENS spheres into upper and lower halves of assembly |
| 1708 | Pool | hypothetical water level atop which plurality of |
| | | Compound Eye HEXLENS float, as determined by cell |
| | | weight and density |
| 1709 | Solar incidence | Depicted solar incidence angle to cell-surface |
| 1710 | Inert Gas | Air within plurality of balls is replaced by inert gas or |
| | | compound, e.g., Ar, N2, CO2, etc. |

FIG. 6, FIG. 6A

| | | |
|---|---|---|
| 1701 | Compound lens | One of 19 transparent, opaque or translucent spherical |
| | | balls welded into a rigid floatation-ball assembly thereby |
| | | forming core elements of a Compound-Eye-HEXLENS-Cell |
| | | and uniformly packed at optimum geometry within an |
| | | equal-sided hexagonal frame (Skirt) #1703 |
| 1702 | Surface lattice | A horizontal planar sheet composed of same plastic as said |
| | | floatation balls into which the plurality of said balls are |
| | | welded uniformly into said planar sheet such that said |
| | | plurality of balls are divided into upper and basal |
| | | hemispheres, accordingly, forming a honeycomb-like |
| | | structure |
| 1703 | Outer wall skirt | an equal-sided hexagonal-frame welded to, and of same |
| | | thickness as said surface lattice, extending downwards |
| | | vertically beneath Pool surface (#1708) to depth sufficient |
| | | as to preclude outside ambient air from circulating |
| | | amongst said lattice/hemisphere interface |
| 1703A | Outer wall, upper | a hexagonal frame welded to, and of same |
| | | dimensions as #1703, extending upwards vertically above |
| | | horizontal plane of lattice #1702; thence upper half of cell |
| | | is a mirror image of lower half of cell, thereby creating an |
| | | invertible cell, accordingly |
| 1705 | magnetic disc | Thin magnetic disc of (+) or (−) polarity embedded flush to |
| | | center point surfaces of alternating wall (skirt) panels |
| 1706 | HEXLENS position | Relative positioning of adjacent Compound-Eye-HEXLENS |
| | | cells with respect to image detail of a central Cell |
| 1707 | Horizontal center line | A reference marker showing division of the Compound-Eye |
| | | HEXLENS spheres into upper and lower halves of assembly |
| 1708 | Pool | hypothetical water level atop which plurality of |
| | | Compound Eye HEXLENS float, as determined by cell |
| | | weight and density |
| 1709 | Solar incidence | Depicted solar incidence angle to cell-surface |
| 1710 | Inert Gas | Air within plurality of balls is replaced by inert gas or |
| | | compound, e.g., Ar, N2, CO2, etc. |

FIG. 7, FIG. 7A

| | | |
|---|---|---|
| 1701 | Compound lens | One of 19 transparent, opaque or translucent spherical |
| | | lens molded within two separate horizontal lattices of |
| | | same polymer such that upper and lower hemispheres are |
| | | truncated equally at fraction of sphere to extent that the |
| | | plurality of resultant Compound-Eye-spheres is formed |
| | | into a one-piece floatation cell of single volume wherein |
| | | the upper component of said Compound-Eye-Cell being |
| | | separated by height “H”, is mirror image of the lower half |
| | | of same floatation device, and wherein the perimeter of |
| | | Cell is a hexagonal frame (Skirt) #1703 |
| 1702 | lattice | One of two horizontal planar sheets composed of same |
| | | plastic as said floatation balls into which the plurality of |
| | | said balls are welded uniformly to said planar sheets such |
| | | that said plurality of balls are truncated into upper and |
| | | basal hemispheres, or fractions of hemispheres therein |
| | | accordingly, forming two honeycomb-like compound-lens |
| | | structures; the upper and base assemblies of which are |
| | | mirror images of each other |
| 1703 | Outer wall | a uniform six-sided hexagon “Skirt” of height “h”, being of |
| | | sufficient depth as to ensure base assembly of said |
| | | compound lens is fully immersed below the Pool surface, |
| | | maximizing energy transfer into working pond media |
| | | within |
| 1705 | magnetic disc | Thin magnetic disc of (+) or (−) polarity embedded in/on, |
| | | center points of alternating wall (skirt) panels |
| 1706 | HEXLENS position | Relative positioning of Compound-Eye-HEXLENS cells with |
| | | respect to image detail of a central Cell |
| 1707 | Horizontal ctr. line | A reference marker showing division of the Compound-Eye |
| | | HEXLENS spheres into upper and lower halves of assembly |
| 1708 | Pool | hypothetical water level atop which plurality of |
| | | Compound Eye HEXLENS float, as determined by total cell |
| | | weight and selected polymer density. |
| 1709 | Solar incidence | Depicted solar ray incidence angle to cell surface |
| 1710 | Inert Gas | Air within the totality of Cell is replaced by inert gas or |
| | | compound, e.g., Ar, N2, CO2, at a nominal pressure. |

FIG. 7B

| | | |
|---|---|---|
| 1701 | Compound lens | One of 19 transparent, opaque or translucent spherical |
| | | lens molded within two separate horizontal lattices of |
| | | same polymer such that upper and lower hemispheres are |
| | | truncated equally at fraction of sphere to extent that the |
| | | plurality of resultant Compound-Eye-spheres is formed |
| | | into a one-piece floatation cell of single volume wherein |
| | | the upper component of said Compound-Eye-Cell being |
| | | separated by height “H”, is mirror image of the lower half |
| | | of same floatation device, and wherein the perimeter of |
| | | Cell is a hexagonal frame (Skirt) #1703 |
| 1702 | lattice | One of two horizontal planar sheets composed of same |
| | | plastic as said floatation balls into which the plurality of |
| | | said balls are welded uniformly to said planar sheets such |
| | | that said plurality of balls are truncated into upper and |
| | | basal hemispheres, or fractions of hemispheres therein |
| | | accordingly, forming two honeycomb-like compound-lens |
| | | structures; the upper and base assemblies of which are |
| | | mirror images of each other |
| 1703 | Outer wall | a uniform six-sided hexagon “Skirt” of height “h”, being of |
| | | sufficient depth as to ensure base assembly of said |
| | | compound lens is fully immersed below the Pool surface, |
| | | maximizing energy transfer into working pond media |
| | | within |
| 1705 | magnetic disc | Thin magnetic disc of (+) or (−) polarity embedded in/on, |
| | | center points of alternating wall (skirt) panels |
| 1706 | HEXLENS position | Relative positioning of Compound-Eye-HEXLENS cells with |
| | | respect to image detail of a central Cell |
| 1707 | Horizontal ctr. line | A reference marker showing division of the Compound-Eye |
| | | HEXLENS spheres into upper and lower halves of assembly |
| 1708 | Pool | hypothetical water level atop which plurality of |
| | | Compound Eye HEXLENS float, as determined by total cell |
| | | weight and selected polymer density. |
| 1709 | Solar incidence | Depicted solar ray incidence angle to cell surface |
| 1713 | Insulating Foam | Air within the totality of Cell is replaced by Closed or Open |
| | | Cell Foam-insulation composed of same polymer as |
| | | HEXLENS Cell Structural components |

FIG. 8, FIG. 8A

| | | |
|---|---|---|
| 1701 | Compound lens | One of 19 transparent, opaque or translucent spherical |
| | | lens molded within two separate horizontal lattices of |
| | | same polymer such that upper and lower hemispheres are |
| | | truncated equally at fraction of sphere to extent that the |
| | | plurality of resultant Compound-Eye-spheres is formed |
| | | into a one-piece floatation cell of single volume wherein |
| | | the upper component of said Compound-Eye-Cell being |
| | | separated by height “H”, is mirror image of the lower half |
| | | of same floatation device, and wherein the perimeter of |
| | | Cell is a hexagonal frame (Skirt) #1703 |
| 1702 | lattice | One of two horizontal planar sheets composed of same |
| | | plastic as said floatation balls into which the plurality of |
| | | said balls are welded uniformly to said planar sheets such |
| | | that said plurality of balls are truncated into upper and |
| | | basal hemispheres, or fractions of hemispheres therein |
| | | accordingly, forming two honeycomb-like compound-lens |
| | | structures; the upper and base assemblies of which are |
| | | mirror images of each other |
| 1703 | Outer wall | a uniform six-sided hexagon “Skirt” of height “h”, being of |
| | | sufficient depth as to ensure base assembly of said |
| | | compound lens is fully immersed below the Pool surface, |
| | | maximizing energy transfer into working pond media |
| | | within |
| 1704 | Tension strap | Vertical ties between upper and lower assemblies |
| | | limit effect of differential expansion of Cell body due to |
| | | high temperature changes within said Cell body |
| 1705 | magnetic disc | Thin magnetic disc of (+) or (−) polarity embedded in/on, |
| | | center points of alternating wall (skirt) panels |
| 1706 | HEXLENS position | Relative positioning of Compound-Eye-HEXLENS cells with |
| | | respect to image detail of a central Cell |
| 1707 | Horizontal ctr. line | A reference marker showing division of the Compound-Eye |
| | | HEXLENS spheres into upper and lower halves of assembly |
| 1708 | Pool | hypothetical water level atop which plurality of |
| | | Compound Eye HEXLENS float, as determined by total cell |
| | | weight and selected polymer density. |
| 1709 | Solar incidence | Depicted solar ray incidence angle to cell surface |
| 1710 | Inert Gas | Air within the totality of Cell is replaced by inert gas or |
| | | compound, e.g., Ar, N2, CO2, at a nominal pressure. |

FIG. 9, FIG. 9A

| | | |
|---|---|---|
| Spherical cap assy. | | Closed, two-uniform polymer sheets, each composed of |
| | | 19 spherical caps (Cap) of radius r2 > r1 welded to each |
| | | other at strategic points on opposing planar sides and |
| | | separated by minimal Height h2, such that internal gas |
| | | temperature within Cell body is consistent throughout |
| 1711 | Compound lens (Cap) | One of 19 transparent, opaque, or translucent Caps |
| | | welded to a rigid surface Lattice assembly thereby |
| | | forming core elements of a Compound-Eye-HEXLENS-Cell |
| | | and uniformly packed at optimum geometry within an |
| | | equal-sided hexagonal frame (Skirt) #1703 & 1703A |
| 1702 | Surface lattice | Two horizontal planar sheets (Lattices) separated by |
| | | height “h2” and composed of same plastic as said Caps |
| | | into which the plurality of said Caps are welded in convex |
| | | attitude to said planar sheet such that said plurality of Cells are |
| | | divided into upper and basal hemispheres, accordingly, forming a |
| | | honeycomb-like structure comprising a total of 38 upper and |
| | | lower Caps |
| 1703 | Outer wall Skirt | an equal-sided hexagonal-frame welded to, and of same |
| | | thickness as said surface lattice, extending downwards |
| | | vertically, beneath Pool surface (#1708) to depth sufficient as to |
| | | preclude outside ambient air from circulating beneath said lattice/ |
| | | pond media interface, and by |
| 1703A | O.W. Skirt, upper ½ | Height of Skirt is extended above horizontal C.L. same |
| | | amount as below for said Cell to be of invertible design |
| 1705 | magnetic disc | Thin magnetic disc of (+) or (−) polarity embedded flush to |
| | | center point surfaces of alternating wall (skirt) panels |
| 1706 | HEXLENS position | Relative positioning of adjacent Compound-Eye-HEXLENS |
| | | cells with respect to image detail of a central Cell |
| 1707 | Horizontal center line | A reference marker showing division of the Compound-Eye |
| | | HEXLENS spheres into upper and lower halves of assembly |
| 1708 | Pool | hypothetical water level atop which plurality of |
| | | Compound Eye HEXLENS float, as determined by cell |
| | | weight and density |
| 1709 | Solar incidence | Depicted solar incidence angle to cell-surface |
| 1710 | Inert Gas | Air within plurality of balls is replaced by inert gas or |
| | | compound, e.g., Ar, N2, CO2, etc. |
| 1712 | Cap Radius, r2 | A spherical cap of radius > r1, reducing the vertical profile |
| | | of plurality of Cells in the Compound-Eye-pond cover |

What is claimed is:

1. A floating pond cover comprised of a plurality of floating hemispheres (Balls) packed in a closed hexagonal frame composed of polymer of uniform thickness, e.g., t1=1.52 mm (or 60 mils); but not limited to said value, composed of transparent, opaque or translucent plastics, base (Body) of same material of same thickness, described herein as a Compound-Eye-HEXLENS Pond Cover; wherein said lens and hexagonal base is of dimensions and airtightness to allow floatation of the assemblage to >50% buoyancy in a salt-gradient-solar-pond (SGSP), or other fluid-retention pond, the apparatus comprising: a hexagonal frame of equal-sides (Skirt) of height “H”-cm welded to two lattice planes of same polymer; one comprising a convex upper lattice-hemispheres-construct, wherein the plurality of hemispheres, or hemisphere-caps are all of equal radius of curvature, thickness and height above said Lattice-plane: “Compound-Eye-Lens” assembly facing upwards vertically, thence said assembly absorbing direct beam solar irradiance, and, separated by a height of “H” cm, a mirror-image copy of same ‘Compound-Eye-Lens” inverted and floating convex-side-inverted on the surface of said SGSP pond;
a plurality of refracting transparent convex hemispheres, e.g., 19 (Compound Lenses) extending upward from a top horizontal x-y plane of a hexagon-shape floatation device (“Skirt”), wherein each of said convex lens centered convex-side up, on a central z-axis of said convex lens, wherein the thickness of said Lens material is same as that of said Skirt, such that incident near-ultraviolet, visible, and infrared rays reaching Earth's surface (A ranging from 290-400 nm, 400-700 nm, and 700-2450 nm, respectively) are refracted through the lens and body, into the saltwater, or concentrated seawater (Brine) stored in a salt-gradient-solar-pond (SGSP), wherein the photons impart energy to said Brine via intermolecular vibration of the salt ions—water solution, causing Brine temperatures to rise in stratified gradients of upper-convective (UCZ), middle-non-convective (NCZ), and lower convective (LCZ) zones of increasing temperatures, the LCZ being of highest salts-ions concentration and density, and accordingly of maximum TES capacity;
the maximum diameters of plurality of the spherical balls are determined in accordance with said closed-hexagonal base-cell dimensions, and stability of the plurality of the completely deployed Compound HEXLENS floating liner system (Field) during anticipated local meteorologic conditions.

2. The floating pond cover of claim 1 wherein said Lattice and Compound-Eye-Lens assembly is welded in totality to base perimeter of said Skirt such that the entire apparatus (Cell) is both air and watertight, thence being a one-piece positive-thermal-insulation cell, solar-energy-collector, and, thereby being an invertible cell, is dumped in large quantity, e.g., >10\hat{ }6 Cells, in the larger SGSP lagoons without regard to upside/downside cell orientation, thence saving labor costs accordingly.

3. The floating pond cover of claim 1 wherein said plurality of Compound-Eye-HEXLENS cells comprise a composition being of a 100% recyclable, durable plastic, e.g., PET, or polyethylene terephthalate, or other organic compound; HDPE and LDPE being likely candidates, which properties include superior transmissibility of direct beam irradiance, resistance to degradation caused by UV radiation, impact resistance, and temperature extremes ranging from, at least −40° C.<t<120° C., and wherein, the Lens hemisphere and Body, composed of same polymer, of same thickness are fabricated as a single-unit in accordance with common plastics manufacturing methods

4. The floating pond cover of claim 1 wherein said plurality of Compound-Eye-HEXLENS spheres positioned within the rigid hexagonal framework are mass-produced in sufficient quantity such that upwards of 10\hat{ }6 individual units are dispersed in our larger SGSPs, wherein due to the hexagonal nature of each Body, naturally tend to contact each other on mutual sides, forming a floating mat of said HEXLENS elements, covering the pond surface in its entirety, to >99% full coverage, in all variations of the HEXLENS pond-cover-system.

5. The floating pond cover of claim 1 wherein the enclosed volumes of the plurality of HEXLENS elements of claim 1, during manufacturing process, are purged of ambient air and filled with an inert gas, e.g., Argon, thereby adding a slight insulation value to said elements, and, preventing growths of mold or algae deposits on inside surfaces of said HEXLENS elements, thereby preventing degradation of said Compound-Eye HEXLENS material and optical performance, or, furthermore, for applications requiring maximum insulation, are packed in totality of the evacuated air-space with a solid “Closed-or-open-Cell” Foam of composition being that of the specific polymer used in the Cell-construct of the plurality of Compound-Eye-HEXLENS Cell.

6. The floating pond cover of claim 1 wherein the plurality of Balls within the plurality of Cell-Frames (“Skirts”) being an assemblage of nineteen upper-hemispheres, and nineteen lower-hemispheres per hexagonal cell, are packed at a maximum theoretical density within said Skirt, and naturally absorb direct beam irradiance throughout the effective daytime solar collection cycle, typically being that, at latitudes of 23°-35° at local solar-time of: 0800 h<TS<1600 h; or that being irrespective of the solar altitude angle, if the Sun's position is high enough for the solar rays to clear the pond-bank profile and, strike and be refracted thru the plurality of convex upper hemispherical-surfaces of said plurality of spheres without casting significant shadows on the plurality of adjacent HEXLENS elements (six) to which plurality of said Cells are mutually connected to one-another via floatation-contact.

7. The floating pond cover of claim 1, further comprising a thin magnetic disc or ferrous strip embedded in, and exactly on-center of each of the six-faces of the hexagonal floatation base in the plurality of HEXLENS Cells, said thin magnetic disc or ferrous strip comprising a diameter (e.g., d=<2 cm), wherein polarity of each magnet, (+or −) is opposite to each other on all consecutive sides of said HEXLENS Cell, thereby providing additional floatation-contact-and-hold by mutual magnetic attraction amongst the six adjacent HEXLENS Cells, and therefore by extension to the totality of HEXLENS Cells in a pond, providing additional resistance against disruption of Field in sites where moderate to high winds are common, accordingly.

8. A floating pond cover comprised of a plurality of floating spheres (Balls) packed in an open hexagonal frame composed of polymer of uniform thickness, e.g., t1=1.52 mm (or 60 mils); but not limited to said value, composed of transparent, opaque or translucent plastics (Cell) of same material of same thickness, described herein as a Compound-Eye-HEXLENS Pond Coven wherein said lens and hexagonal base are of dimensions and airtightness to allow floatation of the assemblage to >50% buoyancy in a salt-gradient-solar-pond (SGSP), or other fluid-retention pond, the apparatus comprising: an Open Hexagonal frame of equal-sides (Skirt) of height “H”-cm welded to outer perimeter of Single Lattice Plane of same polymer; such that said Skirt extends equal heights (H) above and below said Plane to equivalent height as the radius of plurality of Balls welded to, and extending equal heights above and below said single Lattice, thereby forming an invertible “Open-Compound-eye-HEXLENS”, wherein the upper and lower halves of the Cell are mirror-images of each other, accordingly, and are dumped in large quantities, e.g., >10\hat{ }6 Cells, in the larger SGSP lagoons without regard to upside/downside cell orientation, thence saving labor costs accordingly.

9. The floating pond cover of claim 8 wherein the plurality of spherical (COMPOUND-EYE-HEXLENS) comprise a refracting plurality of opaque spheres (Balls) extending equidistance above and below a horizontal x-y plane of a Lattice welded precisely to said Lattice accordingly, and wherein the thickness of said Compound-Eye-HEXLENS elements is the same (e.g., 100 mil), and, thru which incident infrared rays from the portion of the IR spectrum reaching Earth's surface (700-2450 nm) pass through the lens surfaces and surrounding lattice-structure, into the saltwater, or saturated seawater (Brine) stored in a salt-gradient-solar-pond (SGSP), wherein the photons impart energy to said Brine via intermolecular vibration of the salt ions/water solution, causing Brine temperatures to rise and stratify into thermocline gradients of upper-convective (UCZ), middle-non-convective (NCZ), and lower convective (LCZ) zones of increasing temperatures, respectively, thence contributing to improved TES in said SGSP.

10. The floating pond cover of claim 8 wherein the plurality of spherical (COMPOUND-EYE-HEXLENS) cells is each composed of 100% recyclable plastic, e.g., high-density-polyethylene (HDPE), or low-density polyethylene (LDPE) of which properties include: high absorptance in the infrared regime, low albedo, high impact strength, low toxicity to the atmosphere, salt or freshwater, or other working media stored within the plurality of ponds, and durable composition suited to a service-life of up to 25 years.

11. The floating pond cover of claim 8, wherein said Compound-Eye-Cell comprises a very low profile and is deemed necessary for adverse ambient conditions at lagoon sites, e.g., high winds; accordingly, the radii of the plurality of balls forming the (COMPOUND-EYE-HEXLENS) are increased by a specific factor, e.g., r2=1.5*(r1), such that all hemisphere components of the plurality of lens elements are replaced by refracting “Spherical Caps”, welded atop same lattice, instead.

12. The floating pond cover of claim 8 wherein the plurality of Compound-Eye-HEXLENS Cells of are composed of a polymer with a high albedo (e.g., ab=0.95), thereby maximizing reflection of incident beam irradiance into space, whilst optimizing insulation of media stored in lagoons and ponds in the tropics or sub-tropics where constant ambient temperatures are required, examples of which include freshwater pond storage for human/agriculture consumption, and seawater pond storage wherein lower temperatures are required, as said seawater media “make-up-media” is utilized in fish farming (mariculture) industries, and passive storage of that seawater rejection which need be returned to the ocean with minimum adverse environmental consequences, accordingly.

13. The floating pond cover of claim 8 wherein the plurality of Compound-Eye-HEXLENS Cells of are composed of a transparent plastic, thereby optimizing the absorptance of near UV, visible light, and I.R. irradiance into the pond media therein, whilst optimizing insulation of media stored in lagoons and ponds where above-ambient temperatures are required, examples of which include freshwater pond storage in subarctic-temperate climates for human/agriculture consumption, and seawater pond storage wherein higher temperatures are required, as said seawater media “make-up-media” is utilized in fish farming (mariculture) industries.

14. The floating pond cover of claim 8 wherein the plurality of Compound-Eye-HEXLENS Cells of claim 8 are composed of an opaque plastic of black-“mat-finish”-luster, having an albedo of =<3%, thereby optimizing the absorptance I.R. irradiance into the pond media therein, whilst optimizing insulation of media stored in lagoons and ponds where above-ambient temperatures are required, examples of which include freshwater pond storage in subarctic-temperate climates for human/agriculture consumption, and seawater pond storage wherein higher temperatures are required, as said seawater media “make-up-media” is utilized in fish farming (mariculture) industries, and Na+CN—chemical solutions working media in the mining industry.

15. The floating pond cover of claim 8 wherein the plurality of Compound-Eye-HEXLENS Cells are composed of a translucent plastic of light or neutral color shade, allowing transmittance of limited visible and I.R irradiance, thereby maintaining insulation properties, and restricting heat transfer into media of narrow temperature-ranges such as open sewage lagoons dependent on optimum critical bacteria-digestion biochemistry to function properly.

16. A floating pond cover comprised of a plurality of Compound-Eye-HEXLENS Cells composed of a plurality of convex Spherical Caps, of r2 being>r1 of equivalent sphere element, welded to one of two Lattice-sheets of same polymer composition being, but not limited to PET, HDPE, or LDPE, and of same thickness, at maximum hexagonal packing density within a closed Hexagon Frame (Skirt), and, welded to a second Lattice-sheet of same exact dimensions and same plurality of Spherical Caps, to the inverse side of both Lattice-sheets such that the pair of cover elements are mirror images of each other, and are either welded to each other directly, or by a plurality of point-attachment fasteners, thereby fabricating a nominal gap-spacing (h2=0 cm) to (h2=y cm), where “y” is a positive integer or fraction thereof, between the upper and lower assemblies, and,
Are welded to the inside of a uniform-dimensioned hexagonal Frame (Skirt) which height and depth from a horizontal-reference center line are equal, and wherein said gap (h2) is extended into the construct of said “Skirt”, thereby contributing to a balanced floatation of the entire Cell, as a one-piece watertight construction.

17. The floating pond cover of claim 16 wherein the plurality of spherical (COMPOUND-EYE-HEXLENS) is a refracting plurality of opaque spheres (Balls) extending equidistance above and below a horizontal x-y plane of a Lattice welded precisely to said Lattice accordingly, and wherein the thickness of said Compound-Eye-HEXLENS elements is the same (e.g., 100 mil), and, thru which incident infrared rays from the portion of the IR spectrum reaching Earth's surface (700-2450 nm) pass through the lens surfaces and surrounding lattice-structure, into the saltwater, or saturated seawater (Brine) stored in a salt-gradient-solar-pond (SGSP), wherein the photons impart energy to said Brine via intermolecular vibration of the salt ions/water solution, causing Brine temperatures to rise and stratify into thermocline gradients of upper-convective (UCZ), middle-non-convective (NCZ), and lower convective (LCZ) zones of increasing temperatures, respectively, thence contributing to improved TES in said SGSP.

18. The floating pond cover of claim 16 wherein the plurality of spherical (COMPOUND-EYE-HEXLENS) cell is composed of 100% recyclable plastic, e.g., high-density-polyethylene (HDPE), or low-density polyethylene (LDPE) of which properties include: high absorptance in the infrared regime, low albedo, high impact strength, low toxicity to the atmosphere, salt or freshwater, or other working media stored within the plurality of ponds, and durable composition suited to a service-life of up to 25 years.

19. The floating pond cover of claim 16 wherein the plurality of Compound-Eye-HEXLENS Cells are composed of a polymer with a high albedo (e.g., ab=0.95), thereby maximizing reflection of incident beam irradiance into space, whilst optimizing insulation of media stored in lagoons and ponds in the tropics or sub-tropics where constant ambient temperatures are required, examples of which include freshwater pond storage for human/agriculture consumption, and seawater pond storage wherein lower temperatures are required, as said seawater media “make-up-media” is utilized in fish farming (mariculture) industries, and passive storage of that seawater rejection which need be returned to the ocean with minimum adverse environmental consequences, accordingly.

20. The floating pond cover of claim 16 wherein the plurality of Compound-Eye-HEXLENS Cells are composed of a transparent plastic, thereby optimizing the absorptance of near UV, visible light, and I.R. irradiance into the pond media therein, whilst optimizing insulation of media stored in lagoons and ponds where above-ambient temperatures are required, examples of which include freshwater pond storage in subarctic-temperate climates for human/agriculture consumption, and seawater pond storage wherein specific temperatures are required, as said seawater media “make-up-media” is utilized in fish farming (mariculture) industries.
